(19) United States
(12) Patent Application Publication
(10) Pub. No.: US 2002/0124256 A1
(43) Pub. Date: Sep. 5, 2002

(54) Program guide display and recording/reproducing apparatus

(76) Inventor: Tetsuya Suzuka, Toyo-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/018,970

(22) PCT Filed: Apr. 27, 2001
(86) PCT No.: PCT/JP01/03682

(30) Foreign Application Priority Data
Apr. 27, 2000 (JP) 2000-128248

(51) Int. Cl. G06F 3/00; H04N 5/445; G06F 13/00

(52) U.S. Cl. 725/55; 725/56; 725/61

(57) ABSTRACT

In a channel selection and video recording reservation of television broadcast programs, there is provided a video recording and playback device that applies a program list display device which can visually display a past video recording state and a guide of programs scheduled to be broadcast.

While on a program guide screen 200 program information cells 207 showing individual program information are arranged on a table having a channel attribute on a horizontal axis 201 and a date and hour attribute on a vertical axis 202, a display filter setting screen 250 is provided so as to restrict the program information cells 207 to be displayed, and only the program information cells 207 showing the program information of the programs having a broadcast day of the week designated by a day-of-the-week designation 253 and a broadcast period of time designated by a time designation 254 are displayed on the program guide screen 200.

### TECHNICAL FIELD

The present invention relates to a video recording and playback device which applies a program list display device for displaying a program list on a screen and to a user interface for a channel selection, video recording, and playback in the video recording and playback device.

### BACKGROUND ART

The number of receivable broadcast channels has been far increased due to digitalization of a television broadcast. Viewers of a digital broadcast will normally find a desired program out of dozens of channels or more channels. Thus, in a digital broadcasting receiver, a user interface technology for assisting viewers' program selection is important.

Further, a variety of devices, such as a Video Tape Recorder (VTR), a Digital Video Disk (DVD), a Hard Disk Drive (HDD) or the like, have been developed as a device which can store a broadcasting signal. These storage devices have been unified/managed into/in a single video recording and playback device as an information terminal for home use. This unified video recording and playback device requires a viewer to decide in which storage device a broadcasting signal is to be stored at video recording. Further, at playback, the video recording and playback device requires the viewer to find a desired program from programs recorded in plural storage devices. Thus, a user interface technology for assisting the program selection at video recording and playback is important.

Two technologies described below are well-known as the user interface technology for channel selection, video recording, and playback.

### (PRIOR EXAMPLE 1)

In a program list display device disclosed in Japanese Published Patent Application No. Hei.11-284929, a desired program is selected from a program list that is displayed on a monitor screen, thereby carrying out video recording reservation for this program. An example of the program list to be displayed will be described with reference to a program guide display screen 100 shown in FIG. 2. Further, the program list display device disclosed in the prior example 1 displays only the program guide display screen 100 shown in FIG. 2 as the program list on the display screen. In FIG. 2, program information cells 107 which show program information for individual programs are arranged on a matrix having channels on a horizontal axis 101 and a broadcast time on a vertical axis 102, and they are selected by a program selection cursor 114. A video recording reservation state, that is, which program is reserved for video recording and in which storage device, is shown by a video recording reservation device mark 120. In an example in FIG. 2, video recording of “professional baseball 1” is being reserved in a Hard Disk (HD).

The program list that is displayed as described above is prepared on the basis of an electronic program guide that is transmitted together with a video signal or the like. The electronic program guide includes categories, outlines or the like as program information, and therefore the program list display device executes a program search by using this program information so as to display the desired program on the display screen.

### (PRIOR EXAMPLE 2)

A program information recording device disclosed in Japanese Published Patent Application No. Hei.11-203840 extracts information of a recorded program from an electronic program guide, stores the same in each storage device, and prepares a recorded program list for each storage device. Thus, the program information recording device employs the recorded program list at the search for the recorded program, thereby to realize a function having a high user operationality such as a keyword search or the like.

As described above, although a program scheduled to be broadcast is guided in the program list display device disclosed in the prior example 1, and the recorded program is guided in the program information recording device disclosed in the prior example 2, these two types of programs cannot be simultaneously guided on a single screen. Therefore, the display screen of the program list display device and the display screen of the program information recording device must be switched back and forth, so as to perform video recording reservation while referring to the past video recording state or so as to select a viewable program from programs on the air and the recorded programs, resulting in less operationality.

Further, since a program list is shown in a certain format that is a matrix for the channels (the horizontal axis 101) and the broadcast time (the vertical axis 102), it is difficult to display only a program having a specific attribute.

Further, in the program list display device, information that is displayed in the program information cells 107 as program information for the programs is fixed. Therefore, it is impossible that a program is initially identified at a rough level and thereafter a final channel selection is carried out on the basis of detailed program information.

Further, the program list display device provides restrictions based on a keyword designation as a means for restricting programs to be displayed on the display screen. However, in a state where a large number of channels exist and a large number of programs are recorded, it is difficult that only restrictions based on keywords allow desired information to be displayed on the screen.

Further, while the program information recording device can decide a device and a position in the device, in which the program is to be stored with reference to a video recording state at video recording reservation, it is difficult for viewers to comprehend states of individual storage devices in a case where the storage devices have an increased capacity and an increased variety. Thus, a more intelligent video recording guide is required.

Accordingly, the present invention is made to solve these problems, and has for its first object to provide a program list display device which can integrally manage a broadcast electronic program guide and information of the recorded programs to display the same as a program list on a single screen.

Further, the present invention has for its second object to provide a program list display device which provides various formats as the formats of the program list and allows the viewer to dynamically change the format of the program list to be displayed.

Further, the present invention has for its third object to provide a program list display device which can dynamically change individual program information that are displayed on the program list on the basis of a viewer's instruction.

Further, the present invention has for its fourth object to provide a program list display device which can efficiently restrict programs to be displayed on the program list in order to search for a desired program.

Further, the present invention has for its fifth object to provide a video recording and playback device which stores a program on the basis of a whole video recording state containing program information of the programs reserved for video recording and program information of the recorded programs and a program list display device which guides a storage position thereof.

### DISCLOSURE OF THE INVENTION

According to Claim 1 of the present invention, a program list display device which is installed in a broadcast receiver having a video recording and playback function and displays a list of program information for a program selection on a display screen comprises: a program list display means for displaying the program information for programs scheduled to be broadcast and the program information for past recorded programs as a program list on a single screen, wherein the program information comprises one or more program attributes of a channel attribute which shows a channel of the program, a date and hour attribute which shows broadcast date and hour of the program, a program name attribute which shows a title of the program, a category attribute which shows a category to which the program belongs, and a media attribute which shows a storage medium in which the program is recorded.

According to the present invention, a future broadcast schedule and a past video recording state can be simultaneously referred to in a single screen, thereby improving user's operationality in a channel selection and video recording reservation of a series of programs.

Further, according to Claim 2 of the present invention, in the program list display device of Claim 1, the program list display means displays the program information as a program list in a two-dimensional array having a first program attribute arbitrarily selected from the plural program attributes on a first axis and a second program attribute arbitrarily selected from the plural program attributes on a second axis.

According to the present invention, a broadcast schedule in the future and a past video recording state can be simultaneously referred to in a single screen, thereby improving user's operationality in a channel selection and video recording reservation of a series of programs.

Further, according to Claim 3 of the present invention, in the program list display device of Claim 1, the program list display means classifies the program information into groups on the basis of a value for a first program attribute arbitrarily selected from the plural program attributes and displays the program information which belong to the respective groups as a program list in a one-dimensional array having a second program attribute arbitrarily selected from the program attribute group on an axis.

According to the present invention, a future broadcast schedule and a past video recording state can be simultaneously referred to in a single screen, thereby improving user's operationality in a channel selection and video recording reservation of a series of programs.

According to Claim 4 of the present invention, in the program list display device of Claim 1, the program list display means dynamically switches between a case where the program list display means displays the program information as the program list in the two-dimensional array having the first program attribute arbitrarily selected from the plural program attributes on the first axis and the second program attribute arbitrarily selected from the plural program attributes on the second axis and a case where the program list display means classifies the program information into groups on the basis of the value for the first program attribute arbitrarily selected from the plural program attributes and displays the program information which belong to the respective groups as the program list in the one-dimensional array having the second program attribute arbitrarily selected from the program attribute group on the axis.

According to the present invention, a display format of the program list can be changed, depending on the objective to search for a program, thereby improving user's operationality in a channel selection.

According to Claim 5 of the present invention, a program list display device which is installed in a broadcast receiver and displays a list of program information for a program selection on a display screen comprises: a program list display means for displaying the program information for programs scheduled to be broadcast as a program list on a single screen, wherein the program information comprises one or more program attributes of a channel attribute which shows a channel on which the program is broadcast, a date and hour attribute which shows date and hour when the program is broadcast, a program name attribute which shows a title of the program, a category attribute into which the program contents are classified, and the program list display means displays the program information as a program list in a two-dimensional array having a first program attribute arbitrarily selected from the plural program attributes on a first axis and a second program attribute arbitrarily selected from the program attribute group on a second axis.

According to the present invention, user's operationality is improved in a channel selection of a series of programs.

Further, according to Claim 6 of the present invention, a program list display device which is installed in a broadcast receiver and displays a list of program information for a program selection on a display screen, comprising: a program list display means for displaying the program information for programs scheduled to be broadcast as a program list on a single screen, wherein the program information comprises one or more program attributes of the channel attribute which shows the channel on which the program is broadcast, the date and hour attribute which shows date and hour when the program is broadcast, the program name attribute which shows the title of the program, the category attribute into which the program contents are classified, and the program list display means classifies the program information into groups on the basis of a value for a first program attribute arbitrarily selected from the plural program attributes and displays the program information which belong to the respective groups as a program list in a one-dimensional array having a second program attribute arbitrarily selected from the program attribute group on an axis.

According to the present invention, user's operationality is improved in a channel selection of a series of programs.

According to Claim 7 of the present invention, in the program list display device of any of Claims 1 to 6, the program list display means dynamically changes the number of program attributes constituting the program information when the program list is displayed.

According to the present invention, a program list corresponding to a phase where a program is searched for can be displayed in consideration of a trade-off between the amount of information held by individual programs and the number of programs to be displayed on a single screen.

According to Claim 8 of the present invention, in the program list display device of any of Claims 1 to 6, when the program list is displayed, the program list display means dynamically change between a case where a title of the program is displayed as the program name attribute for the program to be displayed and a case where a program group is constituted by plural related programs and a name of the program group to which the programs belong is displayed as the program name attribute.

According to the present invention, a program list corresponding to a phase where a program is searched for can be displayed in consideration of a trade-off between the amount of information held by individual programs and the number of programs to be displayed on a single screen.

Further, according to Claim 9 of the present invention, the program list display device of any of Claims 1 to 6 comprises: a designating means for designating an attribute value of the program attribute constituting the program information, wherein the program list display means displays programs corresponding to an attribute value of the program attribute designated by the designating means on the program list, and the program information comprises one or more program attributes of a channel attribute which shows a channel of the program, a date and hour attribute which shows broadcast date and hour of the program, a day-of-the-week attribute which shows a broadcast day of the week of the program, a time attribute which shows a broadcast time of the program, a program name attribute which shows a title of the program, and a media attribute which shows a storage medium in which the program is recorded.

According to the present invention, a program list suitable for various types of program search, for example, program search from a whole broadcast schedule, program search from programs recorded in a certain video recording device, program search from recorded programs and a broadcast schedule of a certain series of programs, or the like, can be displayed.

Further, according to Claim 10 of the present invention, in the program list display device of Claim 9, the designating means designates attribute values of the day-of-the-week attribute and the time attribute, and the program list display means displays programs having a broadcast day of the week and a broadcast time corresponding to the attribute values of the day-of-the-week attribute and the time attribute which values are designated by the designating means on the program list.

According to the present invention, a future broadcast schedule and a past video recording state of the programs to be recorded in reservation of a series of programs can be efficiently displayed in a single screen.

Further, according to Claim 11 of the present invention, in the program list display device of Claim 7, the program list display means displays the program information as a program list in a two-dimensional array having the channel attribute and the date and hour attribute on two axes.

According to the present invention, a program list corresponding to a phase where a program is searched for can be displayed in consideration of a trade-off between the amount of information held by individual programs and the number of programs to be displayed on a single screen.

Further, according to Claim 12 of the present invention, in the program list display device of Claim 8, the program list display means displays the program information as the program list in the two-dimensional array having the channel attribute and the date and hour attribute on two axes.

According to the present invention, a program list corresponding to a phase where a program is searched for can be displayed in consideration of a trade-off between the amount of information held by individual programs and the number of programs to be displayed on a single screen.

Further, according to Claim 13 of the present invention, in the program list display device of Claim 10, the program list display means displays the program information as the program list in the two-dimensional array having the channel attribute and the date and hour attribute on two axes.

According to the present invention, a future broadcast schedule and a past video recording state of the programs to be recorded in reservation of a series of programs can be efficiently displayed in a single screen.

Further, according to Claim 14 of the present invention, a video recording and playback device which is installed in a broadcast receiver and records and plays back a video signal by employing storage media, comprises: a video recording state list display means for dividing a whole storage area held by the storage media into successively accessible storage units for each recorded content to perform management thereof and displaying information concerning the storage units as a video recording state list on a display screen, wherein the video recording state list display means displays a first storage unit in which recorded programs are stored, a second storage unit which is allocated to programs reserved for video recording, and a third storage unit which is unused on a single screen.

According to the present invention, the user can carry out playback without consideration of a header position of a storage device even when there exists a program reserved for video recording, and further, even when there exist many storage media, the related programs can be recorded in the adjacent storage areas in the same storage device.

Further, according to Claim 15 of the present invention, the video recording and playback device of Claim 14 comprises: a video recording reservation means for designating an arbitrary storage unit from a storage unit group displayed on the video recording state list, thereby carrying out video recording reservation of the program in the storage unit.

According to the present invention, the user can carry out playback without consideration of a header position of a storage device even when there exists a program reserved for video recording, and further, even when there exist many storage media, the related programs can be recorded in the adjacent storage areas in the same storage device.

Further, according to Claim 16 of the present invention, in the video recording and playback device of Claim 15, the video recording state list display means list-displays information of the storage units for the respective storage media on the video recording state list and also displays program information of the corresponding program with respect to the first storage unit and the second storage unit, and the program information comprises one or more program attributes of the channel attribute which shows the channel of the program, the date and hour attribute which shows broadcast date and hour of the program, the program name attribute which shows the title of the program, and the category attribute which shows the category to which the program belongs.

According to the present invention, the user can carry out playback without consideration of a header position of a storage device even when there exists a program reserved for video recording, and further, even when there exist many storage media, the related programs can be recorded in the adjacent storage areas in the same storage device.

Further, according to Claim 17 of the present invention, in the video recording and playback device of Claim 16, the video recording state list display means dynamically changes the number of the program attributes constituting the program information when the video recording state list is displayed.

According to the present invention, the user can carry out playback without consideration of a header position of a storage device even when there exists a program reserved for video recording, and further, even when there exist many storage media, the related programs can be recorded in the adjacent storage areas in the same storage device.

Further, according to Claim 18 of the present invention, in the video recording and playback device of Claim 16, when the video recording state list is displayed, the video recording state list display means dynamically changes between a case where the title of the program is displayed as the program name attribute for the program to be displayed and a case where the program group is constituted by plural related programs and the name of the program group to which the programs belong is displayed as the program name attribute.

According to the present invention, the user can carry out playback without consideration of a header position of a storage device even when there exists a program reserved for video recording, and further, even when there exist many storage media, the related programs can be recorded in the adjacent storage areas in the same storage device.

Further, according to Claim 19 of the present invention, in the video recording and playback device of Claim 17, when the video recording state list is displayed, the video recording state list display means dynamically changes between a case where the title of the program is displayed as the program name attribute for the program to be displayed and a case where the program group is constituted by plural related programs and the name of the program group to which the programs belong is displayed.

According to the present invention, the user can carry out playback without consideration of a header position of a storage device even when there exists a program reserved for video recording, and further, even when there exist many storage media, the related programs can be recorded in the adjacent storage areas in the same storage device.

Further, according to Claim 20 of the present invention, in the video recording and playback device of Claim 16, when the program is reserved for video recording by the video recording reservation means, the video recording state list display means, in which the program group is constituted by the plural related programs, displays the vicinity of the storage unit in which the program which belongs to the same program group as the program reserved for video recording is recorded as a candidate of the storage unit which stores the program reserved for video recording.

According to the present invention, the user can carry out playback without consideration of a header position of a storage device even when there exists a program reserved for video recording, and further, even when there exist many storage media, the related programs can be recorded in the adjacent storage areas in the same storage device.

Further, according to Claim 21 of the present invention, in the video recording and playback device of Claim 17, when the program is reserved for video recording by the video recording reservation means, the video recording state list display means, in which the program group constituted by the plural related programs, displays the vicinity of the storage unit in which the program which belongs to the same program group as the program to be reserved for video recording is recorded as a candidate of the storage unit which stores the program to be reserved for video recording.

According to the present invention, the user can carry out playback without consideration of a header position of a storage device even when there exists a program reserved for video recording, and further, even when there exist many storage media, the related programs can be recorded in the adjacent storage areas in the same storage device.

Further, according to Claim 22 of the present invention, in the video recording and playback device of Claim 20 or 21, the program group is constituted by programs having a series of program contents.

According to the present invention, the user can carry out playback without consideration of a header position of a storage device even when there exists a program reserved for video recording, and further, even when there exist many storage media, the related programs can be recorded in the adjacent storage areas in the same storage device.

Further, according to Claim 23 of the present invention, the video recording and playback device of any of Claims 16 to 21 comprises: a program list display means for displaying program information for programs scheduled to be broadcast and program information for past recorded programs as a program list on a single screen, wherein the program list is employed for a selection of a program to be reserved for video recording, and the program information comprises one or more program attributes of the channel attribute which shows the channel of the program, the date and hour attribute which shows broadcast date and hour of the program, the program name attribute which shows the title of the program, the category attribute which shows the category to which the program belongs, and the media attribute which shows the storage medium in which the program is stored.

According to the present invention, the user can carry out playback without consideration of a header position of a storage device even when there exists a program reserved for video recording, and further, even when there exist many storage media, the related programs can be recorded in the adjacent storage areas in the same storage device.

Further, according to Claim 24 of the present invention, in the video recording and playback device of Claim 23, the program list display means displays the program information as a program list in a two-dimensional array having a first program attribute arbitrarily selected from the plural program attributes on a first axis and a second program attribute arbitrarily selected from the plural program attributes on a second axis.

According to the present invention, the user can carry out playback without consideration of a header position of a storage device even when there exists a program reserved for video recording, and further, even when there exist many storage media, the related programs can be recorded in the adjacent storage areas in the same storage device.

Further, according to Claim 25 of the present invention, in the video recording and playback device of Claim 23, the program list display means classifies the program information into groups on the basis of a value for a first program attribute arbitrarily selected from the plural program attributes and displays the program information which belong to the respective groups as the program list in the one-dimensional array having the second program attribute arbitrarily selected from the program attribute group on the axis.

According to the present invention, the user can carry out playback without consideration of a header position of a storage device even when there exists a program reserved for video recording, and further, even when there exist many storage media, the related programs can be recorded in the adjacent storage areas in the same storage device.

Further, according to Claim 26 of the present invention, in the video recording and playback device of Claim 23, the program list display means dynamically switches between a case where the program list display means displays the program information as the program list in the two-dimensional array having the first program attribute arbitrarily selected from the plural program attributes on the first axis and the second program attribute arbitrarily selected from the plural program attributes on the second axis and a case where the program list display means classifies the program information into groups on the basis of the value for the first program attribute arbitrarily selected from the plural program attributes and displays the program information which belong to the respective groups as the program list in the one-dimensional array having the second program attribute arbitrarily selected from the program attribute group on the axis.

According to the present invention, the user can carry out playback without consideration of a header position of a storage device even when there exists a program reserved for video recording, and further, even when there exist many storage media, the related programs can be recorded in the adjacent storage areas in the same storage device.

Further, according to Claim 27 of the present invention, in the video recording and playback device of Claim 23, the program list display means dynamically changes the number of the program attributes constituting the program information when the program list is displayed.

According to the present invention, the user can carry out playback without consideration of a header position of a storage device even when there exists a program reserved for video recording, and further, even when there exist many storage media, the related programs can be recorded in the adjacent storage areas in the same storage device.

Further, according to Claim 28 of the present invention, in the video recording and playback device of any of Claims 24 to 26, the program list display means dynamically changes the number of the program attributes constituting the program information when the program list is displayed.

According to the present invention, the user can carry out playback without consideration of a header position of a storage device even when there exists a program reserved for video recording, and further, even when there exist many storage media, the related programs can be recorded in the adjacent storage areas in the same storage device.

Further, according to Claim 29 of the present invention, in the video recording and playback device of Claim 23, when the program list is displayed, the program list display means dynamically changes between a case where the title of the program is displayed as the program name attribute for the program to be displayed and a case where the program group is constituted by plural related programs and the name of the program group to which the programs belong is displayed as the program name attribute.

According to the present invention, the user can carry out playback without consideration of a header position of a storage device even when there exists a program reserved for video recording, and further, even when there exist many storage media, the related programs can be recorded in the adjacent storage areas in the same storage device.

Further, according to Claim 30 of the present invention, in the video recording and playback device of any of Claims 24 to 26, when the program list is displayed, the program list display means dynamically changes between a case where the title of the program is displayed as the program name attribute for the program to be displayed and a case where the program group is constituted by plural related programs and the name of the program group to which the programs belong is displayed as the program name attribute.

According to the present invention, the user can carry out playback without consideration of a header position of a storage device even when there exists a program reserved for video recording, and further, even when there exist many storage media, the related programs can be recorded in the adjacent storage areas in the same storage device.

### BRIEF DESCRIPTION OF THE DRAWINGS

FIG. 1 is a block diagram of a video recording and playback device that applies a program list display device according to a first embodiment of the present invention.

FIG. 2 is a diagram illustrating an on-screen display for a channel selection guide which display is displayed as a matrix for broadcast channels and a broadcast time according to the first embodiment of the present invention.

FIG. 3 is a diagram illustrating an on-screen display for a channel selection guide which display is subjected to filtering in accordance with a broadcast period of time and a broadcast day of the week according to the first embodiment of the present invention.

FIG. 4 is a diagram illustrating an on-screen display for a channel selection guide which display is displayed as a list for each broadcast channel according to the first embodiment of the present invention.

FIG. 5 is a diagram illustrating an on-screen display for a channel selection guide which display is displayed as a list for each program according to the first embodiment of the present invention.

FIG. 6 is a diagram illustrating a video recording guide on-screen display on which a video recording state including program information of the programs reserved for video recording and program information of the recorded programs is displayed according to the first embodiment of the present invention.

FIG. 7 is a state transition diagram showing an internal control operation of a set top box according to the first embodiment of the present invention.

FIG. 8 is a diagram illustrating a program information model that shows information used for a program guide in the set top box according to the first embodiment of the present invention.

### BEST MODE FOR CARRYING OUT THE INVENTION

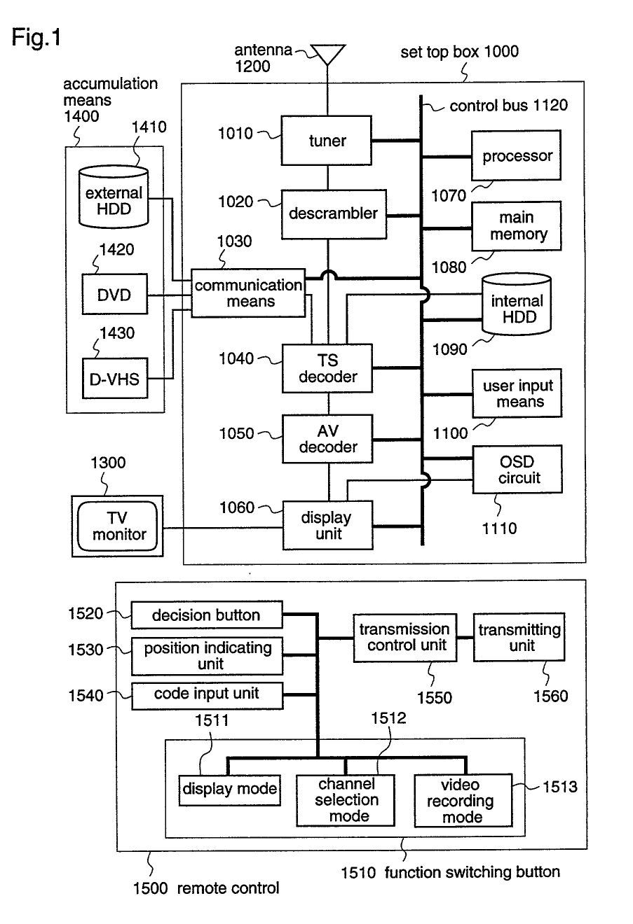

Hereinafter, a first embodiment of the present invention will be described with reference to FIGS. 1 to 8.

(Embodiment 1)

FIG. 1 is a diagram illustrating a structure of a video recording and playback device that applies a program list display device according to the present invention, and a hardware structure according to the first embodiment will be described with reference to FIG. 1. The video recording and playback device is capable of receiving a digital broadcast, video recording, and playback.

In FIG. 1, the video recording and playback device comprises an antenna 1200 for receiving a broadcast wave, a set top box 1000 which controls a decode of a video signal, video recording and playback, an accumulation means 1400 for storing a video signal, a TV monitor 1300 which displays a decoded video signal from the set top box 1000, and a remote control 1500 for transmitting a viewer's instruction to the set top box 1000.

The set top box 1000 is composed of a tuner 1010 which demodulates a broadcast wave from the antenna 1200, a descrambler 1020 which removes an encryption of the video signal, a communication means 1030 for communicating a video signal and control information with the accumulation means 1400, a TS decoder 1040 which executes a protocol process on a transport layer, an AV decoder 1050 which restores voice/video that is compressed in an MPEG (Moving Picture Experts Group) method, a display unit 1060 which converts an audio/video signal into a television signal, a processor 1070 which controls the whole operation, a main memory 1080 which is the storage device for an operation of the processor 1070, an internal hard disk drive (internal HDD) 1090 which stores management information of the set top box 1000, a user input means 1100 which receives the user operation that is transmitted through the remote control 1500, an OSD circuit 1110 which prepares an On-Screen Display (OSD) for user interface such as a program guide, and a control bus 1120 which connects respective components.

The accumulation means 1400 has an external hard disk drive (external HDD) 1410 having a non-portable and random-accessible storage medium, a digital video disk recorder (DVD) 1420 having a portable and random-accessible storage medium, and a video tape recorder (D-VHS) 1430 having a portable and sequential-accessible storage medium.

The remote control 1500 comprises a function switching button 1510 for switching an operation mode of the set top box 1000, a position designating unit 1530 for moving a cursor on the OSD, a code input unit 1540 for inputting an ASCII code to a code input field on the OSD, a decision button 1520 for deciding an operation for the OSD, a transmission control unit 1550 which encodes a user operation, a transmitting unit 1560 which transmits the encoded user operation. The function switching button 1510 includes a display mode button 1511, a channel selection mode button 1512, and a video recording mode button 1513.

Next, a processing flow in a case where the broadcast wave is displayed on the TV monitor 1300 will be described. In a broadcast station, a video signal is MPEG-compressed for each screen and divided into 188-byte-length transport packets. When the transport packet is for a pay program, a payload unit thereof is encrypted. Thereafter, the transport packets from plural programs are multiplexed and modulated so as to be transmitted as a broadcast wave. On the broadcast wave, transport packets which store control information such as PSI (Program Specific Information) and SI (Service Information) are also multiplexed except the transport packets of the video signal. The PSI includes information for selecting a program, decryption information for removing an encryption for the pay program, and the like. Further, the SI corresponds to the electronic program guide and is guide information for programs to be broadcast.

The broadcast wave that is received by the antenna 1200 is demodulated by the tuner 1010 and converted into the transport packet. In a case where the transport packet that is inputted to the descrambler 1020 is for the pay program, the transport packet is outputted after removing the encryption; otherwise, the transport packet is outputted as it is. The TS decoder 1040 extracts the PSI and the SI from the received transport packet and stores the same in the main memory 1080. Further, the TS decoder 1040 extracts the transport packet for the selected program and frames compressed video data. The compressed video data are decoded by the AV decoder 1050 and given to the display unit 1060. The display unit 1060 overlaps an inputted moving picture and an OSD screen produced by the OSD circuit 1110, thereafter converts the same into the television signal, and outputs the same to the TV monitor 1300. The processor 1070 sets the decryption information in the descrambler on the basis of information on the main memory 1080 and the internal HDD 1090 and indicates the selected program to the TS decoder 1040.

When the program is recorded, the TS decoder 1040 extracts the transport packet of the program to be recorded and gives the same to the communication means 1030. The communication means 1030 communicates with the storage device (the external HDD 1410, the DVD 1420, or the D-VHS 1430) in the accumulation means 1400, thereby to store the inputted transport packet in the storage device. Further, as temporary video recording of the program, the transport packet from the TS decoder 1040 can be directly stored in the internal HDD 1090. A video recording instruction to the TS decoder 1040 and the communication means 1030 is issued by the processor 1070.

When the recorded program is played back, a data flow has the opposite flow to a data flow in a case where the program is recorded. That is, the communication means 1030 reads the transport packet of the program to be played back from the storage device in the accumulation means 1400, or reads the transport packet of the program to be played back from the internal HDD 1090. The read packet is inputted to the TS decoder 1040 and thereafter displayed through the AV decoder 1050 and the display unit 1060 on the TV monitor 1300 as in the processing flow of the broadcast wave.

Next, a data flow for a user operation will be described. The remote control 1500 receives viewer's operations in accordance with the function switching button 1510, a decision button 1520, a position indicating unit 1530, and the code input unit 1540. The received user operation is encoded to transmitted data in a transmission control unit 1550, and the data are transmitted by the transmitting unit 1560 as an electromagnetic wave signal. The electromagnetic wave signal is received by the user input means 1100, decrypted, and transmitted through the control bus 1120 to the processor 1070.

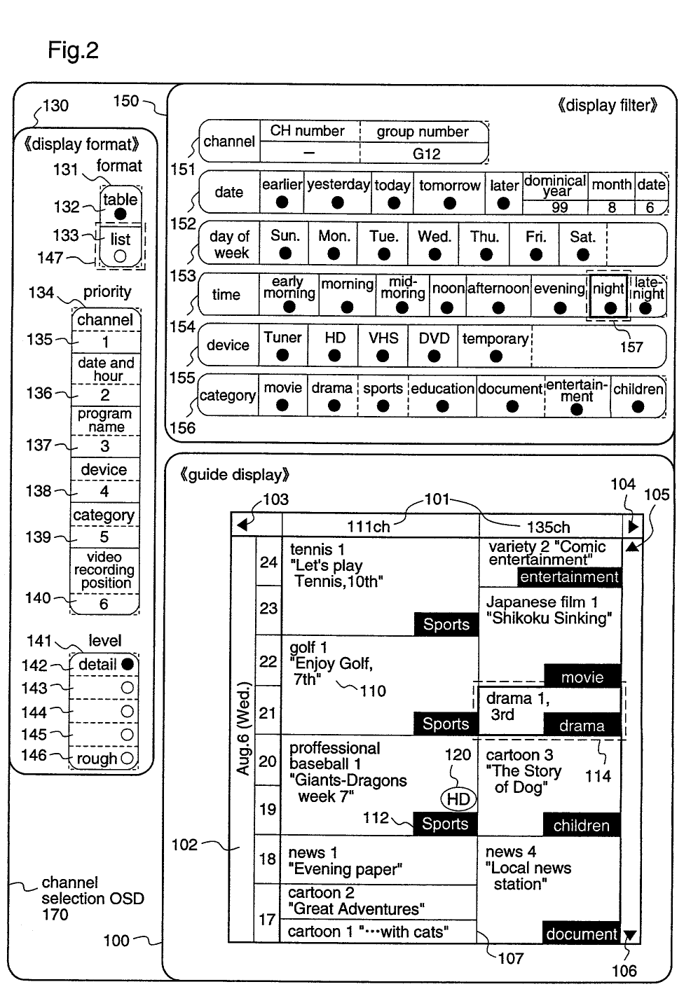

The processor 1070 prepares the OSD screen and displays the same through the OSD circuit 1110 on the TV monitor 1300. The OSD screen includes a channel selection OSD for indicating a program to be viewed and a program to be recorded and a video recording OSD for indicating a storage device, and a position in the device, in which the program indicated to be recorded is to be stored. FIG. 2 is a diagram illustrating an example of the channel selection OSD, and a user interface using the OSD will be described with reference to FIG. 2. In FIG. 2, the channel selection OSD 170 comprises a program guide display screen 100 which displays the program information, a display format setting screen 130 for indicating its display format, and a display filter setting screen 150 for restricting programs to be displayed on the program guide display screen 100.

On the program guide display screen 100 in FIG. 2, the program information cells 107 which show individual program information are arranged on a matrix having channels on a main attribute display row (a horizontal axis) 101 and date and hour on a sub-attribute display column (a vertical axis) 102. The program information cell 107 comprises a program name mark 110 for displaying a program name, a category mark 112 which shows a category to which the program belongs, and a video recording reservation device mark 120 which shows a storage device for the program reserved for video recording. The selection of the program is executed by operating the position indicating unit 1530 of the remote control, moving the program selection cursor 114 to the desired program information cell 107, and pressing the decision button 1520. Scrolling to the column of the program information cell 107 in the horizontal axis direction is indicated by scroll bars 103 and 104 of the main attribute display row, and scrolling to the row of the program information cell 107 in the vertical axis direction is indicated by scroll bars 105 and 106 of the sub-attribute display column.

A display mode of the program guide display screen 100 can be dynamically changed by the user. In FIG. 2, while the program guide display screen 100 is displayed as a table having the channels on the horizontal axis 101 and the date and hour on the vertical axis 102, the display format can be dynamically changed in accordance with a setting of the display format setting screen 130. Further, while the program name attribute, the category attribute, and the video recording device attribute are displayed in the program information cell 107 in FIG. 2, the program attribute to be displayed can be also changed in accordance with the setting of the display format setting screen 130.

The display format setting screen 130 is a screen for indicating a display format of the program guide display screen 100 and includes a format-indicating dialog box 131, a priority-indicating dialog box 134, a display-level-indicating dialog box 141, and a display format setting cursor 147.

In the format-indicating dialog box 131, two formats, that is, a table 132 and a list 133 can be alternatively selected as the display format of the program guide display screen 100. The user operates the position indicating unit 1530 of the remote control and moves the display format setting cursor 147 to the table 132 or the list 133, and, when the decision button 1520 is pressed, the display format of the program guide display screen 100 is changed to the format indicated by the cursor. Thereby, the user can select a program list that is list-displayed in a form in which alignment is performed as the table or a program list that is list-displayed as the list. In the first embodiment, selected items are shown by black circle widgets, and non-selected items are shown by white circle widgets. When the table 132 is selected as in FIG. 2, on the program guide display screen 100, the program information cells 107 which show individual program information are arranged on the matrix having the main attribute of the program (channels in FIG. 2) on the horizontal axis 101 and the sub-attribute of the program (date and hour in FIG. 2) on the vertical axis 102. A case where the list 133 is indicated as the format will be described later.

In the priority-indicating dialog box 134, regarding each attribute of each program information, a priority for displaying the corresponding attribute value is set. The user operates the position indicating unit 1530 of the remote control and moves the display format setting cursor 147 to a certain attribute item (for example, date and hour 136), whereby an input of a priority value from the code input unit 154 enables setting the priority of the attribute. In FIG. 2, a channel attribute has a priority 1 to which a top priority is given, and a video recording position attribute has a priority 6 that is the lowest priority.

The designation of the priority-indicating dialog box 134 enables changing a display axis of the program guide display screen 100. That is, in a case where a table format 132 is indicated, the top priority attribute (in FIG. 2, the channel attribute) is displayed on the main attribute display row 101 as the horizontal axis, and the second highest priority attribute (in FIG. 2, the date and hour attribute) is displayed on the sub-attribute display column 102 as the vertical axis. When the channel attribute and the date and hour attribute are on axes as in FIG. 2, a normal program list that is displayed by the program list display device described in the prior example 1 is obtained. Further, when the video recording device is on an axis, a recorded program list for each video recording device which list is displayed by the program information recording device described in the prior example 2 is obtained. Further, when the program name attribute is on an axis, a past video recording history and a future broadcast schedule for the desired program can be displayed.

Further, in FIG. 2, the program information cells 107 that are displayed in the program guide display screen 100 can be particularly designated in accordance with conditions of the respective attribute values of the programs. The designation of the program to be displayed can be carried out by the user employing the display filter setting screen 150.

On the display filter display screen 150, a program to be displayed on the program guide display screen 100 is designated in accordance with the attribute values of the respective channel attributes, that is, the channel attribute, a date attribute, a day-of-the-week attribute, a time attribute, a device attribute, and a category attribute.

On the display filter setting screen 150, while the channel-designating dialog box 151 indicates a channel number to be displayed, it can indicate the channel number so as to directly perform a display and also indicate the same so as to group the channels and display the group number as the channel number. The date-designating dialog box 152 indicates a range of the date to be displayed. The day-of-the-week-designating dialog box 153 indicates the broadcast day of the week to be displayed. The time-designating dialog box 154 indicates the broadcast period of time to be displayed. The device-designating dialog box 155 indicates the device in which the program has been recorded. The category-designating dialog box 156 indicates a category to which the program belongs.

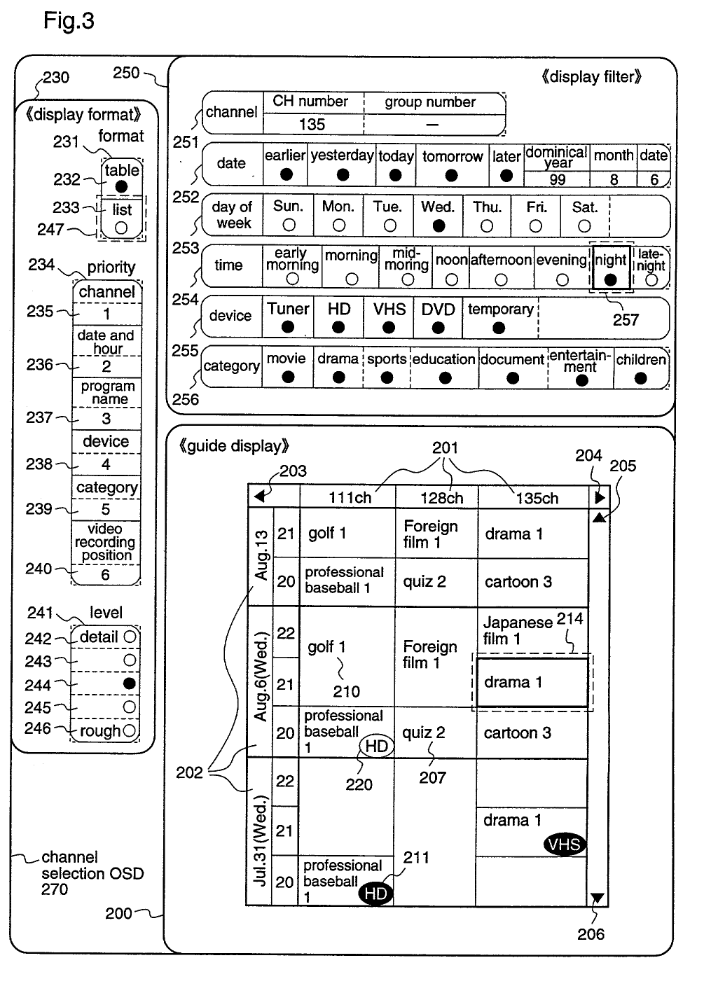

FIG. 3 is a diagram illustrating an example of a channel selection OSD that restricts the programs to be guide-displayed in accordance with the broadcast day of the week and the broadcast period of time. On the program guide display screen 200, only the programs having the broadcast day of the week that is indicated by the day-of-week-designating dialog box 253 of the display filter setting screen 250 and the broadcast period of time that is indicated by the time-designating dialog box 254, that is, only the programs whose broadcast day is Wednesday and whose broadcast period of time is at night (from 20:00 to 23:00) are displayed. On the program guide display screen 200, the programs to be broadcast at night of this Wednesday, August 6, the programs scheduled to be broadcast on next Wednesday, August 13, and the programs that were recorded on last Wednesday, July 31, are simultaneously displayed. Thereby, in the video recording reservation of a drama 1 to be broadcast today, it gets easier to select the device in which the program is to be stored or to simultaneously make video recording reservation of next week's broadcasts, on the basis of the last week's video recording state. The video recording device mark 211 indicates in which storage device the recorded program has been recorded.

On the channel selection OSD 270, the programs to be guide-displayed are restricted in accordance with the broadcast day of the week and the broadcast period of time, thereby displaying the past video recording state and the programs scheduled to be broadcast in the future in a single screen. Thereby, in the video recording reservation of a series of programs, it gets easier to refer to the future broadcast schedule and the past video recording state. While the programs to be displayed are restricted in accordance with the broadcast day of the week and the broadcast period of time in an example in FIG. 3, it is possible to restrict the programs in accordance with complex conditions among the other attributes (the channel attribute, the date attribute, the device attribute, the category attribute). When only the programs that were broadcast during a certain period are to be displayed, the conditions are set using the date-designating dialog box 252. When only the programs from a specific signal source device are to be displayed, the conditions are set using the device-designating dialog box 255. When only the programs that are classified into a certain category is to be displayed, the conditions are set using the category-designating dialog box 256. It is also possible to restrict the programs to be displayed in accordance with the complex conditions which are obtained by combining the display conditions according to these program attribute values.

A level of detail about program information to be displayed in the program information cells 207 is indicated by a display-level-designating dialog box 241. In an example in FIG. 3, an average level 244 is displayed. Therefore, the category mark 112 that has been displayed in a detailed level 142 in FIG. 2 is not displayed. This is because the lowering of the display level prevents low priority attributes from being displayed. That is, the priority of the category attribute is set low as the priority 5, resulting in an omission of the category mark 112 in FIG. 3. Further, the lowering of the display level also results in a simplification of the program name mark 110. While titles 110 of individual programs (for example, golf 1 “Enjoy Golf, 7th”) are displayed in FIG. 2, they are simplified into series names 210 of the programs (for example, golf 1) in FIG. 3. Here, a series of the program is a program group consisting of plural related programs such as a serial drama.

In this way, the lowering of the display level makes the size of the program information cell 207 small and enables increasing the number of displayable channels in the program guide display screen 200. For example, while only two channels (111ch and 135ch) have been able to be displayed in FIG. 2, the programs of three channels have been able to be displayed in FIG. 3.

In this way, the detail level of the program information that is displayed by the priority-indicating dialog box is dynamically changed, whereby the user can totally search for the programs in the program guide at the rough level and thereafter carry out the guide display only concerning a specific program group at the detailed level.

The table having the channels on the horizontal axis 201 and date and hour on the vertical axis 202 is displayed on the program guide display screen 200 in FIG. 3. Although this table format is suitable for showing the broadcast schedule based on the electronic program guide, the past video recording state cannot be efficiently displayed. Since the recorded programs are fewer than all programs on the air, the program information cells 207 are hardly arranged on the matrix of the channels and the date and hour for the video recording state. In an example in FIG. 3, many empty entries exist in a row showing the video recording state on Wednesday, July 31.

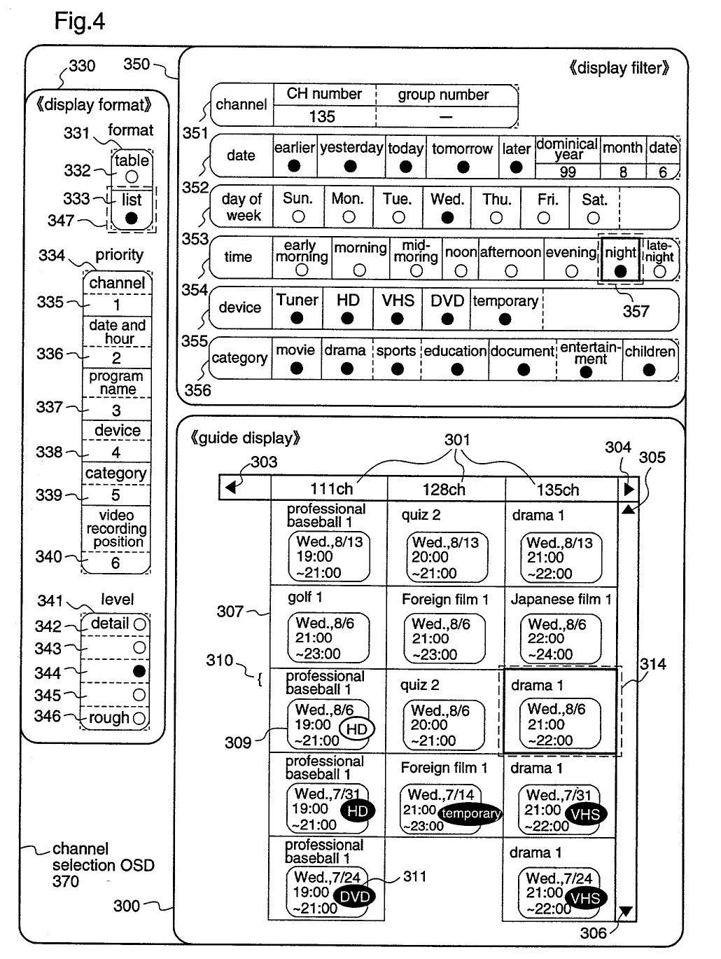

On the other hand, the channel selection OSD shown in FIG. 4 has the same display filter setting 350 as in FIG. 3 and the OSD screen on which the display format of the program guide is a list 333. The program guide display screen 300 in FIG. 4 has the channels as the top priority attribute on the horizontal axis 301 and is the one on which the program information cells 307 are list-displayed for the respective channels. The vertical axis is removed, and the date and hour attribute having the second highest priority is displayed in the program information cells 307 as the broadcast time mark 309. Further, a list of the program information cells 307 for each channel is sorted in accordance with this date and hour attribute value. Thereby, an old recorded program (for example, the professional baseball 1 on Wednesday, July 24) that is not displayed on the table format in FIG. 3 can be displayed, resulting in effective utilization of the screen. However, the program guide on a list format is hard to see as compared with the table format that is displayed in a form where a row is arranged in accordance with the attribute values on the vertical axis. Here, it is necessary to use the screen while dynamically switching between the table format 332 and the list format 333 as appropriate.

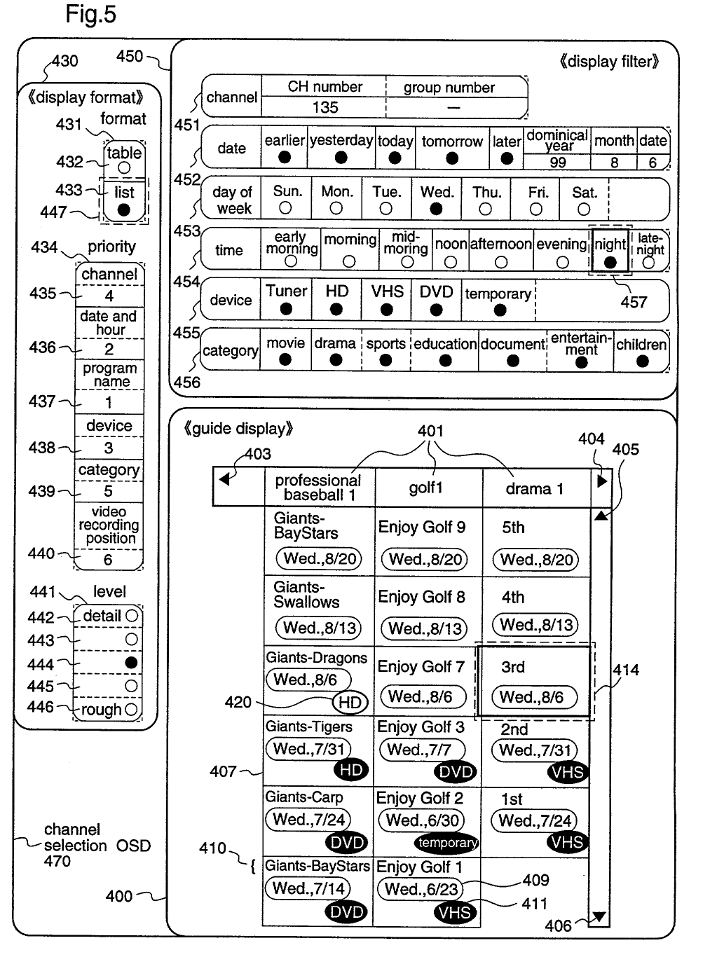

While the channel attribute is on the vertical axis 301 in FIG. 4, the program attribute on the vertical axis 301 can be changed in accordance with the setting of the priority-indicating dialog box. The channel selection OSD 470 shown in FIG. 5 has a list display on which the priority of the program name attribute is taken as top priority and the program name attribute is on the vertical axis 401. The display filter setting 450 restricts the programs to be displayed to the programs whose broadcast day of the week is Wednesday and whose broadcast period of time is at night as in FIGS. 3 and 4. Further, the program name attribute on the vertical axis enables efficiently displaying the past video recording history and the future broadcast schedule for a desired series of programs. In an example of drama 1, it can be confirmed on a single screen that first and second broadcasts are recorded on the D-VHS and third, fourth, and fifth broadcasts are scheduled.

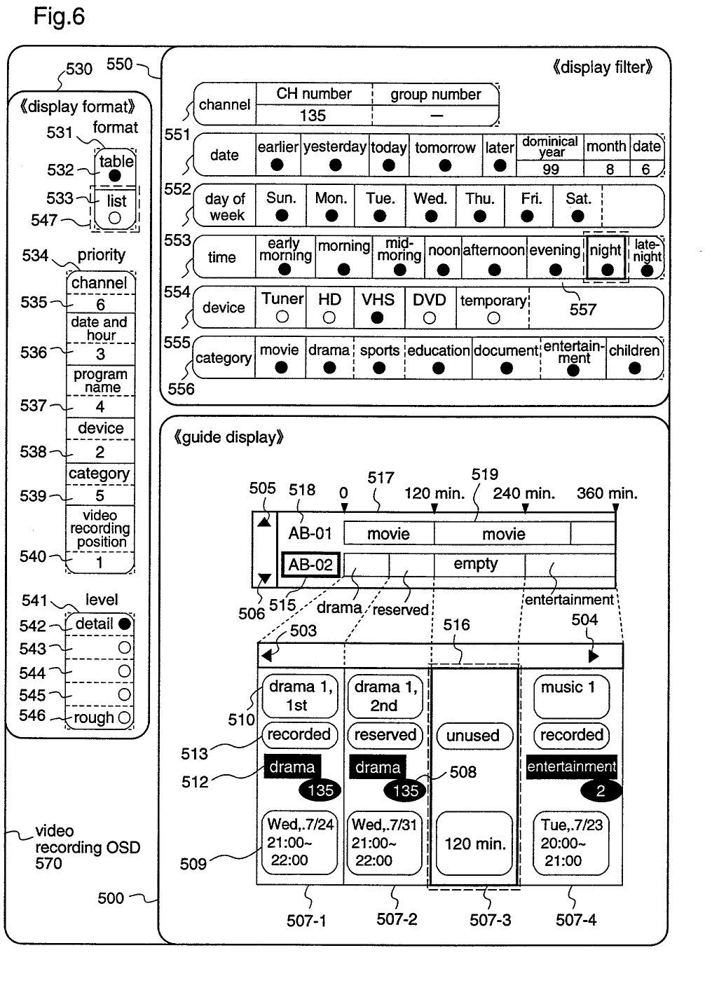

As described above, the user can select the program to be viewed or the program to be reserved for video recording by using the channel selection OSD (170, 270, 370, 470) shown in FIGS. 2, 3, 4, and 5. In a case of video recording reservation, it is necessary to designate a storage device and a position in the device, in which the program to be recorded is to be stored, after deciding the program to be recorded. This is performed by using the video recording OSD 570 in FIG. 6. The program is decided in the channel selection, and thereafter the screen is automatically switched to the video recording OSD 570. The video recording OSD 570 comprises a program guide display screen 500 which displays a video recording state including program information of the programs reserved for video recording and the program information of the recorded programs, a display format setting screen 530 for indicating its display format, a display filter setting screen 550 for restricting the programs to be displayed on the program guide display screen 500.

The display format of the video recording OSD 570 is a table format 532 having the video recording position attribute to which the top priority is given and the device attribute to which the second highest priority is given as a default setting. In an example in FIG. 6, since the VHS is selected by the device-designating dialog box 555, the video recording state map 517 showing the video recording state of the respective D-VHS tapes as the storage medium name 518 on the vertical axis in the program guide display screen 500 is shown. On the video recording state map 517, a recording block mark 519 showing a program that is recorded and a position thereof is displayed for each storage medium name 518.

Regarding the D-VHS tape (tape AB-02 in an example in FIG. 6) that is selected by a storage medium selection cursor 515, information for each storage block mark 519 is displayed by taking the video recording position attribute as the vertical axis. Here, the storage block is an area on the storage medium, stores the same contents and shows a successively accessible area. In a random access type storage medium such as a hard disk or the like, an area where the same program is recorded becomes the storage block, because successive accesses to all the areas are possible. However, in a sequential access type recording medium such as the D-VHS tape or the like, even when the same program is recorded, discontinuous areas become separate storage blocks. The program information cells (507-1,507-4) of the recorded programs are displayed with respect to the storage blocks in which the programs are recorded. The program information cell 507-2 of the reserved program is displayed also with respect to the storage block reserved for video recording. The amount of information in the program information cell to be displayed here is designated by the display-level-designating dialog box 541. An empty cell 507-3 is displayed with respect to an unused storage block. The user indicates the empty cell 507-3 using the video recording position indicating cursor 516, thereby designating in which position storage is to be performed.

The user can indicate in which storage device storage is to be performed in the device-designating dialog box 555 of the display filter setting screen 550 as shown in FIG. 6. Further, the set top box 1000 grasps program information and use states of the storage media, and therefore it can also guide the user such that the same category of programs are recorded in the same storage medium and such that a series of programs can be possibly recorded following the last broadcast.

Further, as shown in FIG. 6, the detail level of information for each storage unit on the video recording OSD 570 can be indicated in the display-level-indicating dialog box 541 by the user. Thereby, some region is decided by roughly displaying a large range of a recording area, and thereafter the storage position can be decided by displaying the region in detail.

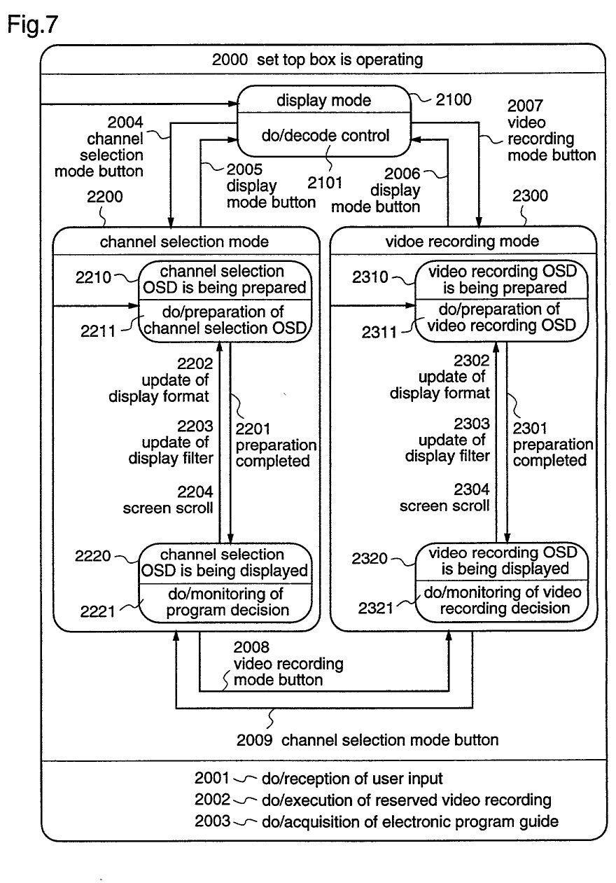

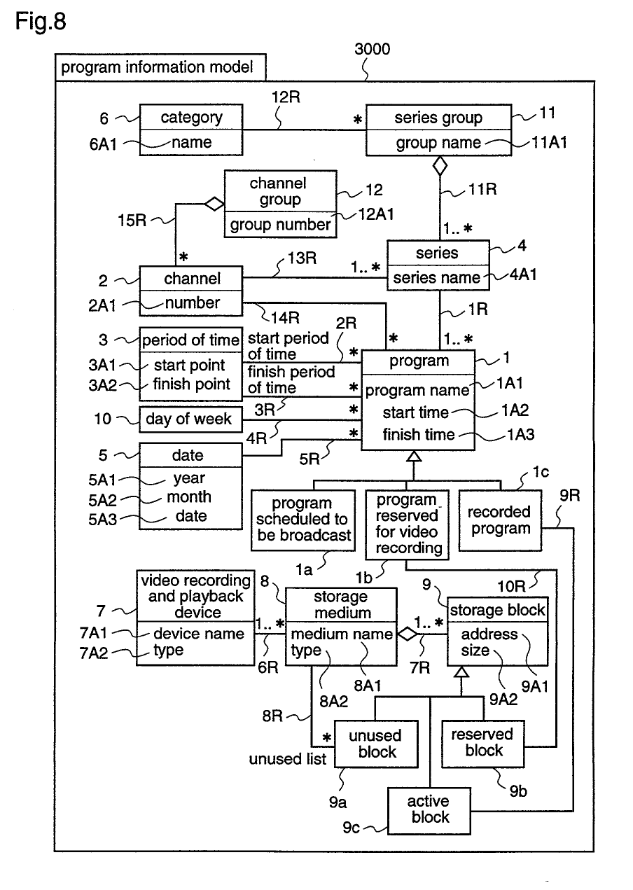

Next, a process that is performed by the set top box 1000 in order to realize the user interface based on the OSD will be described with reference to FIGS. 7 and 8. Expressions used in these drawings comply with a UML (Unified Modeling Language) as a standard that is advised by an OMG (Object Management Group).

FIG. 7 illustrates a state transition diagram of a control operation executed by the processor 1070 in FIG. 1. In a state 2000 where the set top box 1000 is normally operating, a reception 2001 of the user input, an execution 2002 of reserved video recording, and an acquisition 2003 of the electronic program guide are always executed. In the reception 2001 of the user input, the user operation received by the user input means 1100 is received. In the execution 2002 of the reserved video recording, whether the broadcast start time of the program under video recording reservation has come is monitored. When the start time has come, video recording is started, and, when the finish time has come, video recording is finished. In the acquisition 2003 of the electronic program guide, the electronic program guide is prepared on the basis of SI (Service Information) extracted by the TS decoder 1040, and it is stored in the internal HDD 1090 as a program information model 3000 which will be described later. While a case where the electronic program guide is transmitted by the broadcast signal is described in the first embodiment, the present invention can be applied to a case where the electronic program guide is provided by a portable storage medium such as a disk or the like and a case where it is provided by a communication network such as internet or the like.

In a state 2000 where the set top box is operating, either of three sub-states, that is, a display mode state 2100, a channel selection mode 2200, and a video recording mode 2300 is obtained by the user operation.

Immediately after turning the power of the set top box 1000 on, the display mode state 2100 where the received broadcast is displayed on the TV monitor is obtained. In the display mode state 2100, a decode control 2101 is carried out, and the tuner 1010, the descrambler 1020, the TS decoder 1040, the AV decoder 1050, and the display unit 1060 are controlled. Thereby, an image for a broadcast wave received by the antenna 1200 is displayed on the TV monitor 1300.

When the channel selection mode button 1512 is pressed in the display mode state 2100, the transition (2004) is performed to the channel selection mode state 2200. In the channel selection mode state 2200, the above-described channel selection OSD (170, 270, 370, 470) is prepared and displayed. Either of two states, that is, a state 2210 where the channel selection OSD is being prepared and a state 2220 where the channel selection OSD is being displayed is obtained in accordance with situations in which the channel selection OSD is prepared. In an initial state, the state 2210 where the channel selection OSD is being prepared is obtained, a channel selection OSD preparation 2211 is carried out, and the channel selection OSD is prepared on the basis of the program information model 3000 which will be described later.

When a preparation of the channel selection OSD is completed, the transition 2201 is performed to the state 2220 where the channel selection OSD is being displayed. In the state where the channel selection OSD is being displayed, monitoring 2221 of a program decision is carried out, and a program is decided on the basis of the user operation of the prepared channel selection OSD. The transition (2202, 2203, 2204) is performed to the state 2210 where the channel selection OSD is being prepared when the user operation or the like necessitates updating the displayed channel selection OSD. That is, when the setting of the display format setting screen (130, 230, 330, 430) is updated, when the setting of the display filter setting screen (150, 250, 350, 450) is updated, and when the screen is scrolled by the scroll bar (103, 104, 105, 106, 203, 204, 205, 206, 303, 304, 305, 306, 403, 104, 405, 406), the channel selection OSD is prepared again.

When the video recording mode button 1513 is pressed in the display mode state 2100 or the channel selection mode state 2200, the transition (2007, 2008) is performed to the video recording mode state 2300. In the video recording mode state 2300, the video recording OSD 570 is prepared and displayed. An operation in the video recording mode state 2300 is identical with the operation in the above-described channel selection mode 2200 except that the OSD which is prepared and displayed is the video recording OSD. Therefore, a description thereof is omitted.

FIG. 8 illustrates the program information model 3000 which describes information necessary for preparing the OSD. The program information model 3000 is prepared by the received electronic program guide in an action that is carried out while the set top box shown in FIG. 7 is operating, i.e., the “acquisition of the electronic program guide” 2003. This information is used for preparing the channel selection OSD and the video recording OSD in an action, the “channel selection OSD preparation” 2211, and an action, the “video recording OSD preparation” 2311.

In FIG. 8, a quadrangle shows a type of information (hereinafter, referred to as a class). When the quadrangle is divided into two regions, a class name is described in the upper region, and an attribute of the class is described in the lower region. Each data entity belonging to each class is referred to as an object. For example, individual program data such as a program “golf 1, Enjoy Golf, 7th” object, a program “drama 1, 3rd” object or the like belong to a program class 1.

Line segments that connect between classes show relationships between the classes. There are some cases where a sign showing a rule of the class in the relationship and a multiplicity of the relationship is given on the line segment. For example, in the relationship 2R between the program 1 and a period of time 3, a period of time 3 class plays a rule as the start period of time in this relationship, zero or more program objects are related to a period-of-time object (an asterisk means zero or more multiplicities). When the rule of the object in the relationship is obvious and when the multiplicity of the relationship is 1, nothing is described on the line segment.

When one endpoint of the line segment is an outline triangle, it shows a super-sub relation between the classes. For example, the program class 1 is divided into three sub-classes, a program-scheduled-to-be-broadcast class 1a, a program reserved for video recording 1b, and a recorded program 1c. Further, when one endpoint of the line segment is an outline rhomb, it shows an intensive relationship between the classes. For example, a relationship 11R between a series group class 11 and a series class 4 represents that a series group object consists of plural series objects.

The program class 1 corresponds to individual program information and has a program name 1A1, a start time 1A2, and a finish time 1A3 as the attributes. While the start time 1A2 belongs to the period of time such as early-morning, morning, mid-morning, noon, or the like, this assignment relationship is described as a relationship 2R of many-to-one with the period-of-time class 3. To which period of time the finish time 1A3 belongs is described as a relationship 3R. On which channel the program object is broadcast is shown as a relationship 14R of many-to-one with the channel class 2. The day of the week and the date when the program object is broadcast are described as a relationship 4R of many-to-one with a day-of-the-week class 10 and a relationship 5R of many-to-one with the date class 5, respectively.

The program object is classified into either of the program-scheduled-to-be-broadcast class 1a, the program-reserved-for-video-recording class 1b, and the recorded program class 1c in accordance with its recording state. For example, in a case of the program guide display screen 400 in FIG. 5, a “drama, 4th” object belongs to the program-scheduled-to-be-broadcast class 1a, a “Giants-Dragons on August 6” object belongs to the program-reserved-for-video-recording class 1b, and a “drama 1, 1st” object belongs to the recorded program class 1c.

In a program set that constitutes a series of programs, even when the program set is in a program grouping of the same series of programs, there exist one which is newly broadcast and one which is again broadcast. The program grouping having the same contents and the same broadcast mode is expressed as a series class 4. A single series object is broadcast on a single channel, and this is expressed as a relationship 13R of many-to-one with the channel class 2. To which series object a certain program object belongs is described as a relationship 1R. For example, an “Enjoy Golf, 7th” program object is related to a “Golf 1, new broadcast” series object.

A series object group having the same contents and different broadcast modes is expressed as a series group class 11. The series group object is related to the series object group constituting the series group objects by a relationship 11R. For example, the “Golf 1, new broadcast” series object is a component of a “Golf 1” series group object. The broadcast contents of the series group objects are classified into the categories such as movies, dramas, sports, education, or the like, and this is described as a relationship 12R of many-to-one with the category class 6.

Receivable broadcast channels are classified into several groups from viewpoints of user's tastes, the viewing frequency, or the like. This channel set is described as a channel group 12. An object of the channel group is combined with the channel object that is its component by a relationship 15R.

The video recording and playback device such as the internal HDD 1090, the external HDD 1410, the DVD 1420, the D-VHS 1430, or the like is described as a video recording and playback device class 7. A medium such as a disk, a tape, or the like is described as a storage medium class 8, and it is related to the video recording and playback device which accesses the medium by a relationship 6R of many-to-one with the video recording and playback device class 7.

The storage medium 8 comprises plural storage blocks 9. The storage block 9 is an area on the storage medium 8, stores the same contents, and indicates a successively accessible area. In the sequential access type storage medium such as the tape or the like, physically continuous areas that record the same program is the storage block 9. In the random access type storage medium such as the hard disk or the like, normally, a single storage block 9 is in a grouping of physically discontinuous sectors. Whether the accesses to the medium are sequential or random is described as a type attribute 8A2 of the storage medium.

The respective storage block objects are classified into three sub-classes, an unused block class 9a, a reserved block 9b, and an active block 9c, in accordance with the use states thereof. The unused block group is related to the storage medium object by an unused list 8R. The respective reserved blocks are combined with the program reserved for video recording by a relationship 10R of one-to-one. Further, the respective active blocks are combined with the recorded program by a relationship 9R of one-to-one.

Next, how the user interface is realized will be described with reference to the information model 3000. Initially, the channel selection OSD 170 in FIG. 2 will be described. In FIG. 2, since the channel attribute has a top priority, a program to be displayed is searched for by taking the channel attribute value as a key. Here, a channel group G12 is designated in the channel-designating dialog box 151. Therefore, the channel objects 2 (in FIG. 2, 111ch and 135ch) which constitute the channel group object 12 corresponding to the G12 are identified from the channel group object 12 through a relationship 15R. Thereafter, the programs 1 to be broadcast on the respective identified channel objects are found from a relationship 14R.

Since the table format 132 is designated in FIG. 2, and the priority 136 of the date and hour attribute is second, the program group to be displayed, which group is found by the search, is arranged in accordance with the date and hour attribute. Here, Aug. 6, 1999 is designated in the date-designating dialog box 152. Therefore, the program object 1 that is related to the date object 5 corresponding to the designated date is extracted in the information model 3000, and it is sorted by the start time 1A2. Consequently, on the designated channels, the program group to be broadcast on the designated date is obtained as the program group to be displayed in a form in which the program groups are sorted in an order of the broadcast time for each channel.

The program name 1A1 of the program 1 that belongs to the program group to be displayed is displayed as the program name mark 110. Regarding each searched program 1, a category object 6 for the program is found through the relationship 1R, the relationship 11R, and the relationship 12R, and its name 6A1 is displayed as a category mark 112.

When the program to be displayed is the program 1b reserved for video recording, the reserved block 9b that is reserved in order to store the program is found through the relationship 10R. A video recording and playback device object 7 is identified from the block through the relationship 7R and the relationship 6R, and its device name 7A1 is displayed on a video recording reservation device mark 120.

Next, the channel selection OSD 270 in FIG. 3 will be described. Wednesday is designated in the day-of-the-week-designating dialog box 253, and night is designated in the time-designating dialog box 254. Therefore, the searched program group to be displayed is restricted to the programs whose broadcast day of the week is Wednesday and whose broadcast period of time is at night. In the program information model 3000, the program objects 1 which are related to a “Wednesday” day-of-the-week objects 10 by the relationship 5R are extracted from the program objects 1 which belong to the program group. Further, only the program objects 1 which are related to a “night” period-of-time objects 3 by the relationship 2R or the relationship 3R are extracted, and they are taken as the program group to be displayed.

Each program name mark 210 on the program guide display screen 200, whose display level is set as an average level 244 in FIG. 3, shows not each program title but a name of the series group to which the program belongs. In the program information model 3000, regarding each program object 1 belonging to the program group, the series group 11 to which it belongs is identified using the relationships 1R and 11R, and its group name 11A1 is displayed as each program name mark 210.

When the program to be displayed is the recorded program 1c, the active block 9c in which the program is stored is found through the relationship 9R. The video recording and playback device object 7 is identified from the block through the relationships 7R and 6R, and its device name 7A1 is displayed on the video recording reservation device mark 211.

As shown in FIG. 4, when the display format 331 is changed from the table 332 to the list 333, the vertical axis in the guide screen is deleted, the date and hour attribute that has been on the vertical axis is inserted in the program information cells 307 as broadcast time marks 309.

As shown in FIG. 5, when a top priority attribute is changed from the channel attribute to the program name attribute, the program group to be displayed is again searched for. The program indicated by the program selection cursor 414 at the priority change, “drama 1”, is taken as a center, and the indicated program and the programs positioned in the vicinity at the ordering of program names or the like (in an example in FIG. 5, “professional baseball 1” , and “golf 1”) are taken on the horizontal axis 401 on the guide screen. In the program information model 3000, a series 4 to which each program object 1 of each program constituting the horizontal axis 401 belongs is identified by the relationship 1R. A set of the program objects 1 which belong to the series 4 is sorted by the start time 1A2, and the set is taken as a program group to be displayed. While the program information cell 407 is displayed for each program to be displayed, only the date is displayed on the broadcast time mark 409 in a case where the broadcast time of each series is fixed.

When “drama 1, 3rd” is selected by the program selection cursor 414, the video recording OSD 570 in FIG. 6 is displayed. In FIG. 6, the video recording state of the tape AB-02 of the D-VHS is particularly displayed, because the set top box 1000 concludes that the tape AB-02 is preceded as the storage medium which records “drama 1, 3rd”, due to the recorded “drama 1, 1st” 507-1 and “drama 1, 2nd” 507-2 under video recording reservation on this D-VHS tape. The set top box 1000 obtains a series 4 to which the program to be recorded belongs by employing the program information model 3000 and confirms whether or not the program 1b reserved for video recording or the recorded program 1c exists in the program group that belongs to the series 4. When either of them exists, the corresponding storage medium 8 is identified, and it is taken as a candidate that is used in this video recording. Also, regarding the series group 11 and the category 6 to which the program to be recorded belongs, a candidate of the recording medium 8 is identified by a procedure similarly. Each storage medium 8 that is the candidate is estimated in accordance with its goodness of fit, and, with respect to the best fitting storage medium 8, its use state is displayed on the program guide screen 500.

The user can directly indicate a video recording device by the device-designating dialog box 555 in the video recording OSD 570. When no designation of the video recording device from the user is made and no storage medium as the above-described candidate exists, temporary video recording in the internal HDD is taken as a default.

As described above, according to the video recording and playback device which applies the program list display device of the first embodiment, the channel selection OSD which indicates the programs to be viewed and the programs to be recorded comprises the program guide display screen which displays program information, the display format setting screen for indicating its display format, and the display filter setting screen for restricting the programs to be displayed on the program guide display screen. It simultaneously displays program information for the program scheduled to be broadcast on the program guide display screen, program information for the programs currently on the air, and program information for the past recorded programs. Therefore, the programs scheduled to be broadcast and the video recording state can be simultaneously referred to, and the user can dynamically change the display format of the program guide display screen and the programs to be displayed on the program guide display screen, thereby improving user's operationality in the selection of programs and the video recording reservation.

Further, according to the video recording device which applies the program list display device of the first embodiment, the channel selection OSD indicates the program to be recorded, and thereafter the video recording OSD for indicating a recording device in which the program indicated to be recorded is to be recorded, and a position therein, is displayed. Therefore, the programs can be recorded in an adjusted arrangement on the basis of the use states of the storage media.

Further, while in this first embodiment the program guide display screen, the display format setting screen, and the display filter setting screen is simultaneously displayed on a single screen as shown in FIGS. 2-5, these three screens may be displayed separately. That is, there is provided a button for displaying the respective screens on the function switching button 1510 of the remote control 1500, and, only when it is pressed, the corresponding screen is displayed.

Industrial Availability

The present invention is suitable for the user interface which assists the channel selection when the digital broadcast in which the number of receivable broadcast channels has been far increased is viewed and the program selection when the digital broadcast is recorded and played back.

1. A program list display device which is installed in a broadcast receiver having a video recording and playback function and displays a list of program information for a program selection on a display screen, comprising:
a program list display means for displaying the program information for programs scheduled to be broadcast and the program information for past recorded programs as a program list on a single screen, wherein
the program information comprises one or more program attributes of a channel attribute which shows a channel of the program, a date and hour attribute which shows broadcast date and hour of the program, a program name attribute which shows a title of the program, a category attribute which shows a category to which the program belongs, and a media attribute which shows a storage medium in which the program is recorded.

2. The program list display device of claim 1 wherein
the program list display means displays the program information as a program list in a two-dimensional array having a first program attribute arbitrarily selected from the plural program attributes on a first axis and a second program attribute arbitrarily selected from the plural program attributes on a second axis.

3. The program list display device of claim 1 wherein
the program list display means classifies the program information into groups on the basis of a value for a first program attribute arbitrarily selected from the plural program attributes and displays the program information which belong to the respective groups as a program list in a one-dimensional array having a second program attribute arbitrarily selected from the program attribute group on an axis.

4. The program list display device of claim 1 wherein
the program list display means dynamically switches between a case where the program list display means displays the program information as the program list in the two-dimensional array having the first program attribute arbitrarily selected from the plural program attributes on the first axis and the second program attribute arbitrarily selected from the plural program attributes on the second axis and a case where the program list display means classifies the program information into groups on the basis of the value for the first program attribute arbitrarily selected from the plural program attributes and displays the program information which belong to the respective groups as the program list in the one-dimensional array having the second program attribute arbitrarily selected from the program attribute group on the axis.

5. A program list display device which is installed in a broadcast receiver and displays a list of program information for a program selection on a display screen, comprising:
a program list display means for displaying the program information for programs scheduled to be broadcast as a program list on a single screen, wherein
the program information comprises one or more program attributes of a channel attribute which shows a channel on which the program is broadcast, a date and hour attribute which shows date and hour when the program is broadcast, a program name attribute which shows a title of the program, a category attribute into which the program contents are classified, and
the program list display means displays the program information as a program list in a two-dimensional array having a first program attribute arbitrarily selected from the plural program attributes on a first axis and a second program attribute arbitrarily selected from the program attribute group on a second axis.

6. A program list display device which is installed in a broadcast receiver and displays a list of program information for a program selection on a display screen, comprising:
a program list display means for displaying the program information for programs scheduled to be broadcast as a program list on a single screen, wherein
the program information comprises one or more program attributes of the channel attribute which shows the channel on which the program is broadcast, the date and hour attribute which shows date and hour when the program is broadcast, the program name attribute which shows the title of the program, the category attribute into which the program contents are classified, and
the program list display means classifies the program information into groups on the basis of a value for a first program attribute arbitrarily selected from the plural program attributes and displays the program information which belong to the respective groups as a program list in a one-dimensional array having a second program attribute arbitrarily selected from the program attribute group on an axis.

7. The program list display device of any of claims 1 to 6 wherein
the program list display means dynamically changes the number of program attributes constituting the program information when the program list is displayed.

8. The program list display device of any of claims 1 to 6 wherein,
when the program list is displayed, the program list display means dynamically change between a case where a title of the program is displayed as the program name attribute for the program to be displayed and a case where a program group is constituted by plural related programs and a name of the program group to which the programs belong is displayed as the program name attribute.

9. The program list display device of any of claims 1 to 6 comprising:
a designating means for designating an attribute value of the program attribute constituting the program information, wherein
the program list display means displays programs corresponding to an attribute value of the program attribute designated by the designating means on the program list, and
the program information comprises one or more program attributes of a channel attribute which shows a channel of the program, a date and hour attribute which shows broadcast date and hour of the program, a day-of-the-week attribute which shows a broadcast day of the week of the program, a time attribute which shows a broadcast time of the program, a program name attribute which shows a title of the program, and a media attribute which shows a storage medium in which the program is recorded.

10. The program list display device of claim 9 wherein
the designating means designates attribute values of the day-of-the-week attribute and the time attribute, and
the program list display means displays programs having a broadcast day of the week and a broadcast time corresponding to the attribute values of the day-of-the-week attribute and the time attribute which values are designated by the designating means on the program list.

11. The program list display device of claim 7 wherein
the program list display means displays the program information as a program list in a two-dimensional array having the channel attribute and the date and hour attribute on two axes.

12. The program list display device of claim 8 wherein
the program list display means displays the program information as the program list in the two-dimensional array having the channel attribute and the date and hour attribute on two axes.

13. The program list display device of claim 10 wherein
the program list display means displays the program information as the program list in the two-dimensional array having the channel attribute and the date and hour attribute on two axes.

14. A video recording and playback device which is installed in a broadcast receiver and records and plays back a video signal by employing storage media, comprising:
a video recording state list display means for dividing a whole storage area held by the storage media into successively accessible storage units for each recorded content to perform management thereof and displaying information concerning the storage units as a video recording state list on a display screen, wherein
the video recording state list display means displays a first storage unit in which recorded programs are stored, a second storage unit which is allocated to programs reserved for video recording, and a third storage unit which is unused on a single screen.

15. The video recording and playback device of claim 14 comprising:
a video recording reservation means for designating an arbitrary storage unit from a storage unit group displayed on the video recording state list, thereby carrying out video recording reservation of the program in the storage unit.

16. The video recording and playback device of claim 15 wherein
the video recording state list display means list-displays information of the storage units for the respective storage media on the video recording state list and also displays program information of the corresponding program with respect to the first storage unit and the second storage unit, and
the program information comprises one or more program attributes of the channel attribute which shows the channel of the program, the date and hour attribute which shows broadcast date and hour of the program, the program name attribute which shows the title of the program, and the category attribute which shows the category to which the program belongs.

17. The video recording and playback device of claim 16 wherein
the video recording state list display means dynamically changes the number of the program attributes constituting the program information when the video recording state list is displayed.

18. The video recording and playback device of claim 16 wherein,
when the video recording state list is displayed, the video recording state list display means dynamically changes between a case where the title of the program is displayed as the program name attribute for the program to be displayed and a case where the program group is constituted by plural related programs and the name of the program group to which the programs belong is displayed as the program name attribute.

19. The video recording and playback device of claim 17 wherein,
when the video recording state list is displayed, the video recording state list display means dynamically changes between a case where the title of the program is displayed as the program name attribute for the program to be displayed and a case where the program group is constituted by plural related programs and the name of the program group to which the programs belong is displayed.

20. The video recording and playback device of claim 16 wherein,
when the program is reserved for video recording by the video recording reservation means, the video recording state list display means, in which the program group is constituted by the plural related programs, displays the vicinity of the storage unit in which the program which belongs to the same program group as the program reserved for video recording is recorded as a candidate of the storage unit which stores the program reserved for video recording.

21. The video recording and playback device of claim 17 wherein,
when the program is reserved for video recording by the video recording reservation means, the video recording state list display means, in which the program group constituted by the plural related programs, displays the vicinity of the storage unit in which the program which belongs to the same program group as the program to be reserved for video recording is recorded as a candidate of the storage unit which stores the program to be reserved for video recording.

22. The video recording and playback device of claim 20 or 21 wherein
the program group is constituted by programs having a series of program contents.

23. The video recording and playback device of any of claims 16 to 21 comprising:
a program list display means for displaying program information for programs scheduled to be broadcast and program information for past recorded programs as a program list on a single screen wherein
the program list is employed for a selection of a program to be reserved for video recording, and
the program information comprises one or more program attributes of the channel attribute which shows the channel of the program, the date and hour attribute which shows broadcast date and hour of the program, the program name attribute which shows the title of the program, the category attribute which shows the category to which the program belongs, and the media attribute which shows the storage medium in which the program is stored.

24. The video recording and playback device of claim 23 wherein
the program list display means displays the program information as a program list in a two-dimensional array having a first program attribute arbitrarily selected from the plural program attributes on a first axis and a second program attribute arbitrarily selected from the plural program attributes on a second axis.

25. The video recording and playback device of claim 23 wherein
the program list display means classifies the program information into groups on the basis of a value for a first program attribute arbitrarily selected from the plural program attributes and displays the program information which belong to the respective groups as the program list in the one-dimensional array having the second program attribute arbitrarily selected from the program attribute group on the axis.

26. The video recording and playback device of claim 23 wherein
the program list display means dynamically switches between a case where the program list display means displays the program information as the program list in the two-dimensional array having the first program attribute arbitrarily selected from the plural program attributes on the first axis and the second program attribute arbitrarily selected from the plural program attributes on the second axis and a case where the program list display means classifies the program information into groups on the basis of the value for the first program attribute arbitrarily selected from the plural program attributes and displays the program information which belong to the respective groups as the program list in the one-dimensional array having the second program attribute arbitrarily selected from the program attribute group on the axis.

27. The video recording and playback device of claim 23 wherein
the program list display means dynamically changes the number of the program attributes constituting the program information when the program list is displayed.

28. The video recording and playback device of any of claims 24 to 26 wherein
the program list display means dynamically changes the number of the program attributes constituting the program information when the program list is displayed.

29. The video recording and playback device of claim 23 wherein,
when the program list is displayed, the program list display means dynamically changes between a case where the title of the program is displayed as the program name attribute for the program to be displayed and a case where the program group is constituted by plural related programs and the name of the program group to which the programs belong is displayed as the program name attribute.

30. The video recording and playback device of any of claims 24 to 26 wherein,
when the program list is displayed, the program list display means dynamically changes between a case where the title of the program is displayed as the program name attribute for the program to be displayed and a case where the program group is constituted by plural related programs and the name of the program group to which the programs belong is displayed as the program name attribute.
